(19) United States
(12) Patent Application Publication
(10) Pub. No.: US 2009/0036807 A1
(43) Pub. Date: Feb. 5, 2009

(54) MASSAGING VIBRATOR

(75) Inventor: Jacques HABATJOU, Cambrai (FR)

Correspondence Address: OBLON, SPIVAK, MCCLELLAND MAIER & NEUSTADT, P.C., 1940 DUKE STREET, ALEXANDRIA, VA, 22314, US

(73) Assignee: L'OREAL, Paris (FR)

(21) Appl. No.: 12/182,736

(22) Filed: Jul. 30, 2008

Related U.S. Application Data
(60) Provisional application No. 60/954,343, filed on Aug. 7, 2007.

(30) Foreign Application Priority Data
Jul. 30, 2007 (FR) 0756789

(51) Int. Cl. A61H 1/00; H02K 7/06; A61H 7/00

(52) U.S. Cl. 601/72; 310/81; 601/134

(57) ABSTRACT

A massaging vibrator includes a massage assembly provided with a contact member, which is at least partly elastically deformable, and which can be applied directly or indirectly to the skin of a user, and which can be used in a deformed position when a stress is applied by the user. The arrangement also includes a reinforcement for the contact member at least partly embedded inside the contact member, with the reinforcement being able to deform jointly with the contact member and capable of keeping the contact member in the deformed position when the user ceases to apply the stress. The vibrator further includes at least one vibration generator, preferably directly in contact with the reinforcement within the contact member.

### CROSS-REFERENCE TO RELATED APPLICATIONS

This document claims priority to French Patent Application No. 07 56789, filed on Jul. 30, 2007 and U.S. Provisional Application No. 60/954,343, filed Aug. 7, 2007, the entire contents of which are hereby incorporated by reference.

### FIELD OF THE INVENTION

The invention relates to massaging vibrators, and can be particularly advantageous for a vibrator that can be used for locally massaging the epidermis of a male or female user.

### BACKGROUND OF THE INVENTION

### Discussion of Background

A vibrator may also be used to encourage the penetration of a cosmetic or care product into the upper layers of the epidermis of the massaged area. The term “cosmetic product” is understood to mean a product as defined in Directive 93/35/CEE of the Council of 14 Jun. 1993.

Within the field of epidermis massaging, U.S. Pat. No. 6,083,180 describes a massage device which comprises a body and a set of balls housed in an end wall of the body, enabling the epidermis to be massaged when the device is applied to a user's face.

FR 2 162 671 describes a massage device provided with a tensioned elastic wall intended to be applied against the user's skin and with rollers mounted so as to rotate by means of a shaft, so as to impact the elastic wall when moving the device over the skin for the purpose of obtaining a compression effect thereof.

Also known, from FR 1 409 881, is a massage device comprising a body, a pad projecting relative to the body, and a plate for supporting the pad, which can deform elastically under the effect of an electromagnet so as to generate vibrations and to transmit them to the pad.

These devices of the prior art have in particular the drawback of being unable to conform to the morphology of a user's face.

For this purpose, EP-A2-1 726 282 describes a massaging vibrator device provided with a massaging plate made of silicone and with a vibration generator fixed to the plate via a metal reinforcement extending partly inside the latter. In this regard, screws are provided on the reinforcement, projecting from the massage plate so as to mount the vibration generator on one of the faces of the plate. This device has the major drawback of not allowing the vibrations emitted within the massage plate to propagate well.

### SUMMARY OF THE INVENTION

It is an object of the present invention to remedy one or more of the drawbacks of the devices of the prior art.

According one object of the invention, a compact vibrator is provided which is suitable for massaging the surface of a user's epidermis in a particularly effective manner, and to do so comfortably within the entire area massaged.

An example of the invention provides a massaging vibrator comprising a massage assembly provided with a contact member, which is at least partly elastically deformable and intended to be applied directly or indirectly to the skin of a user, especially in a deformed position when a stress is applied by the user. A reinforcement for the contact member is at least partly embedded inside the contact member, with the reinforcement being able to deform jointly with the contact member and capable of keeping the contact member in the deformed position when the user ceases to apply the stress. The vibrator further includes at least one vibration generator directly in contact with the reinforcement within the contact member.

The use of a massage assembly provided with an at least partly elastically deformable contact member and with a reinforcement for the contact member makes it possible for the vibrations emitted by the vibration generator, which is mechanically linked to the reinforcement inside the actual contact member, to be efficaciously transmitted to the user's skin. According to a preferred example, the vibrations emitted by the vibrating generator(s) are transmitted to the reinforcement directly, i.e. via no intermediate element. This ensures effective propagation of the vibrations into the entire contact member.

Thus, a vibrator is provided which can be applied to the area of the face to be massaged and which can conform to the morphology of the face for the purpose of generating vibrations so as to obtain the desired massage effect. According to a preferred example, the vibrator forms a relaxing mask. When using it, it is unnecessary to move the mask so as to obtain the massaging effect.

Moreover, since the reinforcement itself is deformable, it is possible to adapt the massage assembly, including the contact member and the reinforcement, to the user's morphology. The reinforcement furthermore enables the deformation applied to the massage assembly to be maintained.

The term “indirect contact” is understood here to mean the contact that exists between the user's skin and the contact member via an intermediate layer covering the surface of the contact member capable of exerting pressure on the area to be massaged, via a hygienic envelope of the member or else via patches impregnated with an active substance.

Placing the reinforcement at least partly embedded inside the contact member is particularly advantageous for uniformly propagating the vibrations emitted at the contact member, so as to obtain uniform massaging of the entire area massaged.

In one example embodiment, the reinforcement has a shape matching that of the contact member. Thus, the reinforcement extends over the entire surface of the contact member. As an alternate example, the reinforcement may be located only in or on certain areas of the contact member.

Advantageously, by way of example, the contact member is preferably substantially flat before deformation.

According to an example, the vibration generator comprises a motor and a weight driven by the motor. The motor may be configured so as to rotate the weight, which is mounted eccentrically with respect to the motor.

The vibration generator may be flush with a surface of the contact member capable of pressing against the user's skin.

Preferably, the vibration generator is designed to generate vibrations in a plane containing the contact member and parallel to the skin of the user.

In one example of an embodiment, the vibrator has at least two vibration generators, with a first vibration generator generating vibrations in a first plane parallel to the skin of the user and a second vibration generator generating vibrations in a second plane, perpendicular to the first plane.

Also, by way of example, the vibrator can include a reservoir for containing a cosmetic product, especially a moisturising composition. This arrangement is particularly advantageous insofar as it provides massaging of the area of the epidermis to be treated combined with application of a cosmetic product. Furthermore, in the case of a thixotropic product, the vibrations emitted by the vibrator also allow the composition to be mixed before it is applied, so as to ensure that the product is properly homogenized. In this embodiment, the contact member has at least one outlet orifice for the product contained in the reservoir.

According to another example or feature, the vibrator can include a controller or means for controlling the vibration generator. The control means or control arrangement may be capable of varying the frequency and the intensity of the vibrations emitted. Advantageously, by way of example, the control means are mechanical and may comprise a switch, for example of the type comprising a spring.

Preferably, the device includes a gripping body.

By way of example, the contact member is made of plastic. The reinforcement itself may be made of metal, for example made from sheet metal. Alternately, the reinforcement may be made of another material, for example stainless steel, soft iron, titanium, etc.

Also by way of example, the contact member has, when said member is seen from below, at least one excrescence or projection for the purpose of applying the vibrator to the user's skin.

Preferably, the contact member has a trilobal general shape. However, it is also possible to provide other shapes, for example the shape of a water drop. It is also possible to provide a contact member having a rounded central portion joined to two diametrically opposed tapered branches.

According to another feature, a massaging method using a vibrator as defined above is provided, in which the vibrator is applied directly or indirectly to the area of the skin to be massaged, and then the vibration generator of the vibrator is actuated.

Advantageously, the contact member of the vibrator is preferably deformed before or after the vibration generator has been actuated.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

A better understanding of the invention will be gained from reading the following description in conjunction with the accompanying figures. The figures are offered purely as a guide and by way of example, and in no way limit the invention.

FIG. 1 is a view from below of the gripping body of a massaging vibrator according to a first example of an embodiment of the invention;

FIG. 2 is a sectional view on the axis II-II of FIG. 1;

FIG. 3 is a sectional view of the contact member of the massaging vibrator of FIG. 1;

FIG. 4 is a perspective view of the vibrator of FIGS. 1 to 3 during its use;

FIG. 5 is a sectional view of the contact member of a massaging vibrator according to a second example of an embodiment of the invention;

FIG. 6 is a sectional view of the contact member of a massaging vibrator according to a third example of an embodiment of the invention;

FIG. 7 is a view from below of the contact member of a massaging vibrator according to a fourth example of an embodiment of the invention;

FIG. 8 is a view from below of the contact member of a massaging vibrator according to a fifth example of an embodiment of the invention;

FIG. 9 is a view from below of the contact member of a massaging vibrator according to a sixth example of an embodiment of the invention;

FIG. 10 is a sectional view of a massaging vibrator according to a seventh example of an embodiment of the invention; and

FIG. 11 is a sectional view on the axis XI-XI of FIG. 10.

### DETAILED DESCRIPTION OF THE PREFERRED EMBODIMENTS

Referring now to the drawings, like reference numerals are utilized to designate identical or corresponding parts throughout the several views.

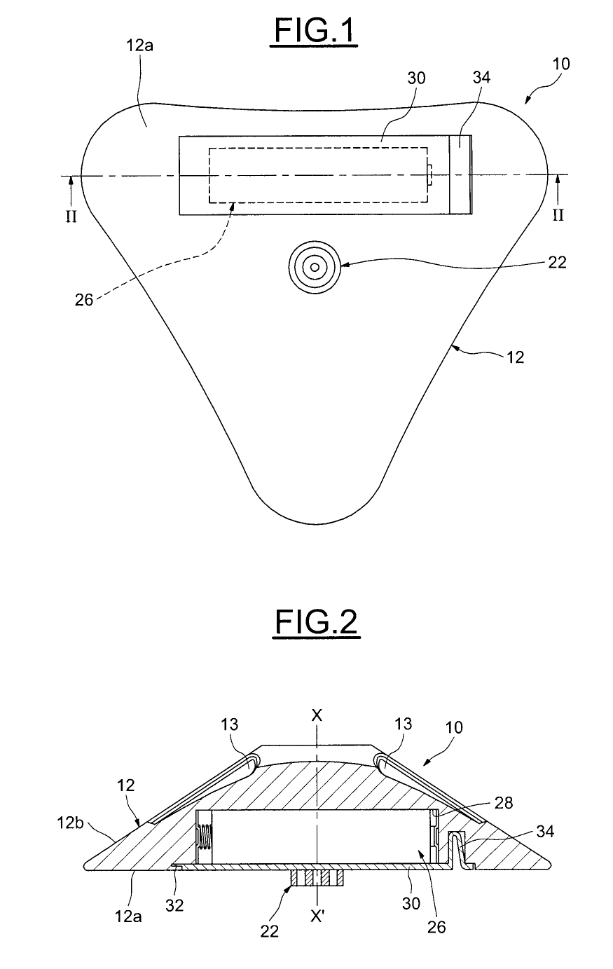

FIGS. 1 to 4 show a massaging vibrator, denoted by the general numerical reference 10, intended to be used for massaging tissue of the epidermis of a user's face. However, it will be readily appreciated that the vibrator 10 may also be used for massaging other parts of the body.

In this example, the vibrator 10 principally comprises a gripping body 12, a contact member 14, intended to be applied against a user's skin, a reinforcement 16 for the contact member 14, and vibration generators 18 capable of transmitting vibrations to the assembly formed by the reinforcement and the contact member.

Advantageously, by way of example, the gripping body 12 is made of a rigid plastic, for example polyethylene (PE) or polypropylene (PP). The body 12 has a flat lower surface 12a and a dome 12b extends from the lower surface in a direction along the axis X-X′. The dome 12b has recesses 13, for example four in number, in order for a user to grip the device 10.

In the illustrated example, the contact member 14 has a trilobal triangular general shape so that an interlobe hollow can pass beneath a user's nose and two of the lobes can press against the cheekbones of the user's face, the other lobe pressing against the chin. Preferably, the contact member 14 takes the form of a thin flat element. It has a small thickness, for example less than fifteen millimeters, so as to be easily deformable by the user's hand and/or face. The contact member 14 has a flat surface 20 intended to come into contact with the user's skin. As will be described in greater detail later, the contact member 14 is fastened to the body 12 by means of a fitting bush 22 centered on the axis X-X′ and extending from the flat lower surface 12a on the opposite side from the dome 12b.

The contact member 14 is made of an elastic material such as silicone, Buna® sold by Bayer, polybutadiene (PBHT), or polyvinyl chloride (PVC). Preferably, a plasticiser, for example castor oil, is incorporated into the elastic material.

In the illustrated example, the reinforcement 16 is entirely embedded inside the contact member 14, for example by overmoulding of the contact member 14. As an alternative, the reinforcement 16 could be mounted so as to bear on the contact member. According to a preferred example, the reinforcement 16 is made of metal, for example made from a metal sheet cut using a cutting press. The reinforcement 16 may also be formed by welding. As an alternative example, the reinforcement 16 may of course be made of another material, for example, stainless steel, soft iron, titanium, etc.

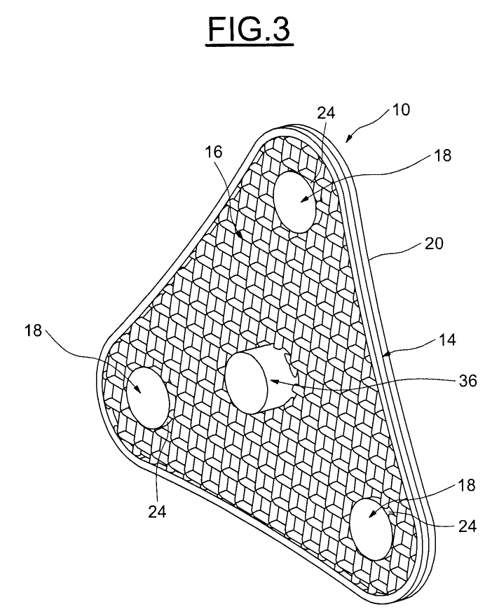

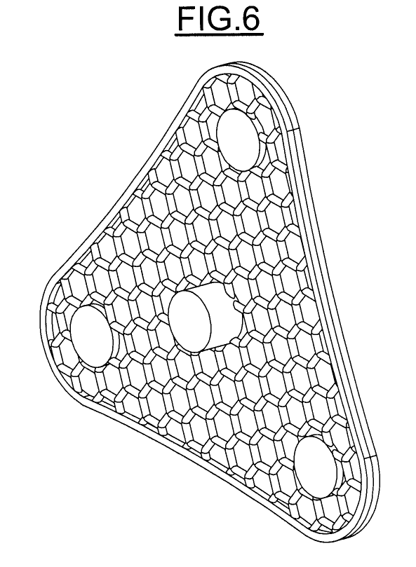

The reinforcement 16 in the example illustrated takes the form of a square-cell mesh, the outer perimeter of which has a shape matching that of the envelope of the contact member 14. The mesh of the reinforcement 16 as illustrated in FIG. 3 is in no way limiting. It could for example be provided as a triangular-cell mesh, as illustrated in FIG. 5, or a hexagonal-cell mesh, as shown in FIG. 6. As a further example, the reinforcement 16 could also take the form of concentric rings linked by radial linking elements, or without radial linking elements. As indicated above, the reinforcement 16 here has a shape matching that of the contact member 14. According to a further alternative example, one or more reinforcements can be located locally in different areas of the contact member 14.

The reinforcement 16 is formed to allow the assembly formed by the reinforcement and the contact member 14 to be easily deformed manually and for this assembly to return to its initial position, for the purpose of being deformed again, without risk of damaging it. In other words, by dint of the shape and/or the nature of the reinforcement 16, it can be easily deformed manually. In a preferred form, the reinforcement can be deformed to form an impression therein, for example, to conform to a shape of a portion of a user's face. The reinforcement can retain a deformed shape or position (thus also maintaining the contact member in a deformed shape), until additional force or stress is applied by the user to return the reinforcement to its original position or another deformed position.

In the illustrated example, the reinforcement 16 includes, at the lobes of the contact member 14, housings 24 for the vibration generators 18. The vibration generators 18 are placed within the contact member 14, these being mechanically linked to the reinforcement 16. They are entirely housed in the contact member 14 in the illustrated example and are flush with the surface of the contact member intended to come into contact with the user's skin in this example.

FIG. 3 shows schematically the vibration generators 18. Each vibration generator 18 comprises an electric motor, provided with a rotary shaft, and an eccentric weight supported by the shaft. Of course, it is also possible to provide other types of vibration generators, and also a different number of generators.

Preferably, the rotary shaft of the electric motor of each vibration generator extends in a direction perpendicular to the axis X-X′ so as to generate vibrations in a plane parallel to the user's skin when the vibration generators 18 are supplied. Alternately, for example, the vibration generators may be placed so as to generate both vibrations in a plane parallel to the user's skin and in a second plane perpendicular to said first plane.

To supply the vibration generators 18, the vibrator 10 includes electrical energy production means or power source 26, for example a battery or cell. The electrical energy production source or means 26 are placed in a housing 28 provided inside the body 12, from the lower surface 12a.

In the example illustrated, to ensure that the electrical energy production source or means 26 are kept in position, the vibrator 10 includes a plate 30 flush with the lower surface 12a of the body 12. In order to fasten it to the gripping body 12, the plate 30 has at one end two lugs 32 and at the other end a resilient tab 34 that fits into recesses (not referenced) provided for this purpose.

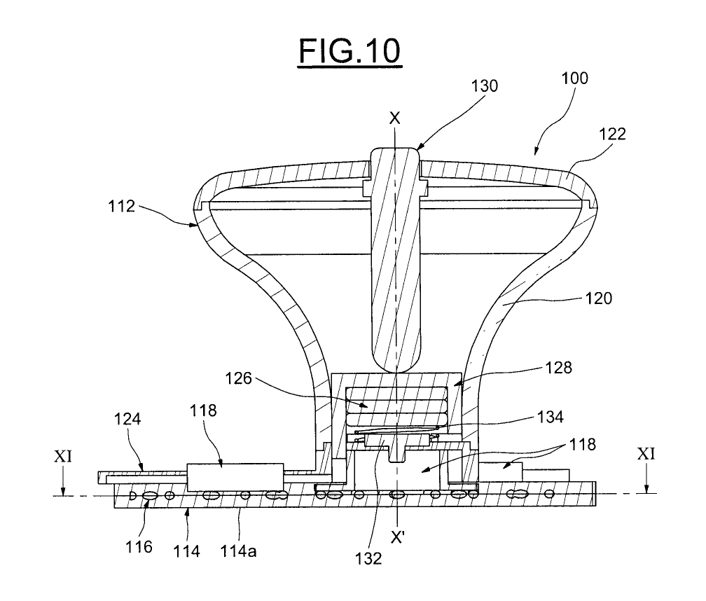

The vibrator 10 also includes a controller or means (not shown in this figure, however, an example of a switch is shown and discussed later in connection with FIG. 10) for controlling the vibration generators 18. The control arrangement or control means is formed by a manually operated mechanical switch preferably mounted at one of the recesses 13 in the body 12, for example. The switch may advantageously have several positions such as, for example, a neutral position, a position operating the motor sequentially, and a position operating the motor randomly. Other positions may also be provided in order to vary the frequency and the intensity of the vibrations emitted.

To mount the contact member 14 on the body 12, the fitting bush 22 fastened to the lower surface 12a of the body 12 is able to be mounted inside a shaft 36 of the contact member 14 that projects therefrom. The shaft 36 and the fitting bush 22 are fastened relative to each other by any suitable fastener or means. In the coupled position, an axial space is provided between the surface 12a of the gripping body 12 and the contact member 14 so as to deform the member.

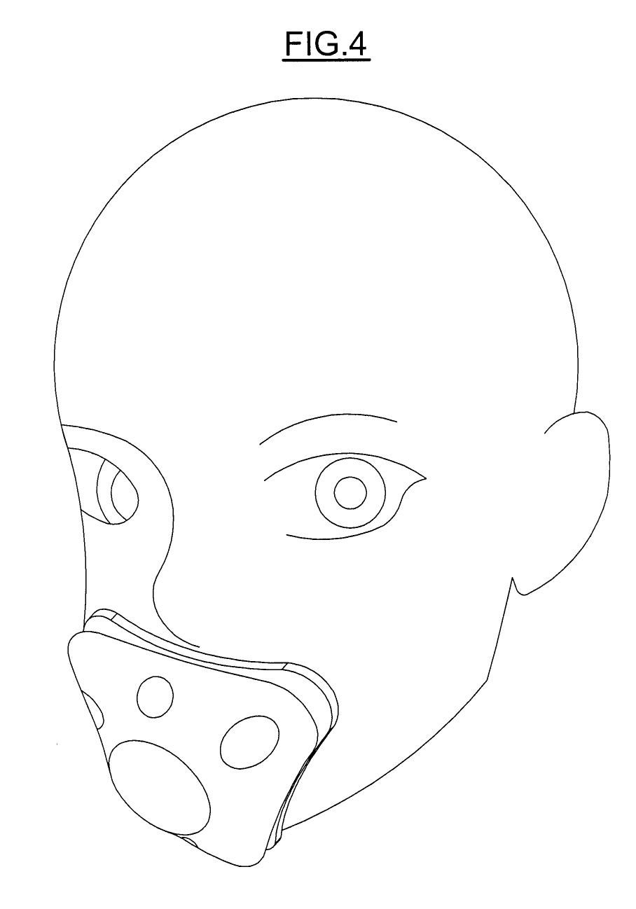

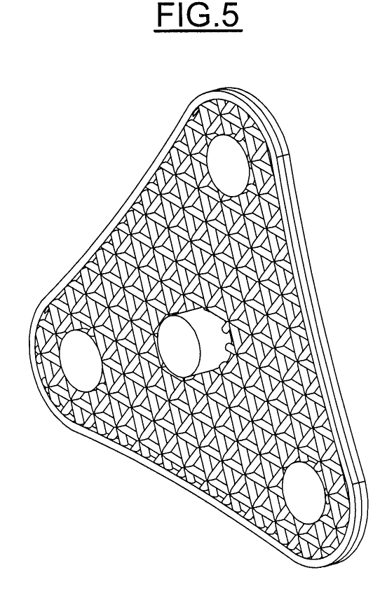

While the vibrator 10 is being used, the contact member 14 is applied against the user's face. The user deforms the assembly formed by the contact member 14 and the reinforcement 16 so as to match the morphology of his or her face, as illustrated in FIG. 4. The user has thus applied an external force to deform this assembly. When the user stops applying force, the rigid reinforcement 16 allows the flexible contact member 14 to be kept in place in this deformed position before, during and after generation of the vibrations.

In other words, the deformable reinforcement 16 enables the contact member 14 to be held in place in the deformed position until the user again exerts pressure or force in a different direction. The reinforcement 16 also allows effective propagation of the vibrations emitted by the vibration generators 18 into the entire contact member 14. In the preferred example illustrated, this is provided by arranging the vibration generators 18 so as to be in direct contact with the reinforcement 16.

In operation, the user may choose to vary the frequency and the intensity of the vibrations emitted by each of the vibration generators 18 according to the desired massage effect.

The vibrator 10 constitutes a vibratory relaxing mask which, once it has been put in place against the user's face and matched to the morphology of the latter, is held fixed in position during vibration generation. It is unnecessary in fact to move the mask to obtain, by friction, the massage effect. Of course, the user may carry out such a movement in order to change the areas of the face massaged.

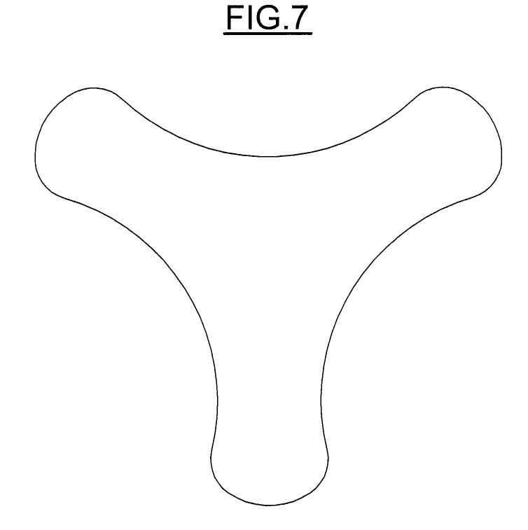

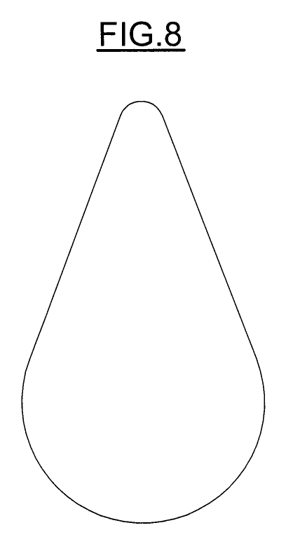

In this embodiment, the contact member 14 has a trilobal general shape so as to match various parts of the user's face. For example, one advantageous application of the vibrator 10 consists in positioning one lobe of the contact member 14 in the chin region of the user and the other two lobes pressing on the cheekbones and jawbones, with the interlobe hollow placed beneath the user's nose. As an alternative, by way of example, it is possible, as illustrated in FIG. 7, to increase the concavity of the portions linking the lobes so as to obtain a modified contact member 14.

Of course, it is also possible to provide contact members having a different number of lobes or excrescences while preferably still keeping, however, a rounded general shape for these salient parts so as to avoid damaging the skin of the area to be massaged.

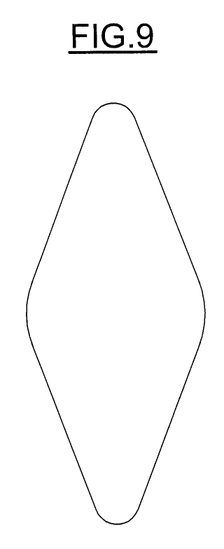

In the example embodiment illustrated in FIG. 8, the contact member 14 takes the form of a water droplet, having a single lobe. In the embodiment shown in FIG. 9, the contact member 14 has a rounded central portion joined to two diametrically opposed tapered branches forming the lobes.

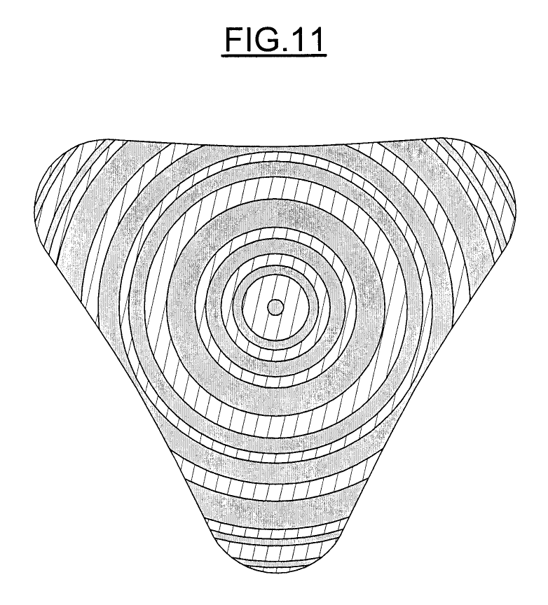

FIGS. 10 and 11 show a massaging vibrator according to a second example of an embodiment of the invention, which is denoted by the general numerical reference 100.

The vibrator 100 comprises a gripping body 112, a contact member 114, intended to be applied against a user's skin, a reinforcement 116 for the contact member, and vibration generators 118 which transmit the emitted vibrations to the assembly formed by the reinforcement and the contact member.

The contact member 114 is similar to that provided in the embodiment of the invention illustrated in FIGS. 1 to 4 and has a contact surface 114a for contacting a user's skin. The reinforcement 116 is entirely embedded inside the contact member and takes the form of rings or ring portions concentric about the axis X-X′.

The gripping body 112 is fastened to the contact member 114 by means of a support plate 124 which is itself fastened to the contact member by any suitable fastener or fastening means. The gripping body 112 is formed by a first part 120 fastened to the support plate 124 and a second part 122 attached to the first part 120. The second part 122 is made of an elastically deformable material, for example polyethylene (PE). In the illustrated example, the gripping body 112 has a mushroom-like general shape in view of the gripping by the user.

The vibration generators 118 in this example are four in number, only three being visible in the figure. Three vibration generators 118 are placed in the lobes of the contact member 114, the fourth vibration generator 118 being centred on the axis X-X′. The vibration generators 118 are partly housed inside the contact member 114 and fastened to the support plate 124. In a manner similar to the embodiments described previously, the vibration generators 118 are directly in contact with the reinforcement 116 within the contact member 114.

The vibrator 100 includes electrical energy production means or a power source 126, formed here by a stack of three batteries or cells placed in a U-shaped housing 128 oriented towards the contact member 114, with the contact member being mounted so as to slide inside the first part 120 of the gripping body 112.

The vibrator 100 also includes a controller or means for controlling the vibration generators 118. For example, these control means can take the form of a switch or push button 130 mounted on the second part 122 of the gripping body 112 and extending axially along the axis X-X′ inside the body until bearing against the housing 128 for the power source or electrical energy production means 126. When the user presses on the push button 130, this causes a slight deformation of the part 122 of the gripping body 112 and moves the housing 128 axially until contact is made with an on/off button 132 for actuating the vibration generators 118.

To allow the push button 130 to return to its initial position, an elastic return member 134, such as a spring, is mounted between the on/off button 132 and the power source or electrical energy production means 126. Thus, the vibrations are emitted only when the user presses on the push button 130 in this example.

In the embodiments described above, it may be possible, in accordance with the scope of the invention, to provide a reservoir of cosmetic product, for example one containing a moisturizing composition, so as to allow the product to be distributed while the user is massaging the epidermis. Preferably, by way of example, the reservoir can be accessible from the recesses in the gripping body, for example, and be made of a deformable material so as to expel product by exerting pressure thereon.

In this regard, the contact member includes at least one outlet orifice for the product or a plurality of orifices uniformly distributed over the contact member, which communicate with the reservoir. With such an arrangement, massaging of the epidermis area to be treated is obtained by the vibrations of the vibration generators can be combined with application of the product. Furthermore, in the case of a heterogeneous moisturizing composition, or else for a thixotropic composition, the vibrations emitted also enable the composition to be properly homogenized before being applied.

According to an alternate example, patches can be provided, placed on the contact member so as to bear against the area to be massaged, with the patches impregnated with an active substance in order to combine massaging of the area to be treated with application of the active substance. Alternatively, a hygienic envelope can be provided, which may or may not be transparent, mounted on the surface of the contact member bearing on the user's skin. Under these arrangements, by way of example, the contact member is applied indirectly against a user's skin.

By way of example, according to one of the advantageous features, a massaging vibrator is provided which includes a massage assembly, comprising a flexible contact member, which is at least partly elastically deformable. In addition, a rigid reinforcement is provided which is itself deformable so as to allow the massage assembly to maintain the deformation applied to it when the vibrator is placed against the user's skin and mounted inside the contact member, with the reinforcement preferably being mechanically linked directly to the vibration generators so as to allow optimum massaging.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A massaging vibrator comprising:
a massage assembly which includes a contact member, which is at least partly elastically deformable and which can be applied directly or indirectly to the skin of a user, wherein the contact member includes a deformed position when a stress is applied by the user;
wherein the massage assembly further includes a reinforcement for the contact member which is at least partly embedded inside the contact member, wherein said reinforcement is deformable jointly with the contact member and maintains said contact member in the deformed position when the user ceases to apply the stress; and
wherein the massaging vibrator further includes at least one vibration generator directly in contact with the reinforcement within the contact member.

2. A vibrator according to claim 1, wherein the reinforcement has a shape matching that of the contact member.

3. A vibrator according to claim 1, wherein the contact member includes an undeformed position in which the contact member is substantially flat.

4. A vibrator according to claim 1, wherein the vibration generator comprises a motor and a weight driven by the motor.

5. A vibrator according to claim 4, wherein the motor is configured so as to rotate the weight, and wherein the weight is mounted eccentrically with respect to the motor.

6. A vibrator according to claim 1, wherein the vibration generator is flush with a surface of the contact member which presses against the skin of the user.

7. A vibrator according to claim 1, wherein the vibration generator generates vibrations in a plane containing the contact member and parallel to the skin of the user.

8. A vibrator according to claim 1, comprising at least two vibration generators, including a first vibration generator which generates vibrations in a first plane parallel to the skin of the user, and a second vibration generator which generates vibrations in a second plane perpendicular to said first plane when the vibration is placed in contact with the skin of the user.

9. A vibrator according to claim 1, further including a reservoir for containing a cosmetic product.

10. A vibrator according to claim 9, wherein the reservoir contains a moisturizing composition.

11. A vibrator according to claim 9, wherein the contact member includes at least one outlet orifice for the product contained in the reservoir.

12. A vibrator according to claim 1, further including control means for controlling the vibration generator.

13. A vibrator according to claim 12, wherein the control means varies the frequency and the intensity of the vibrations emitted.

14. A vibrator according to claim 12, wherein the control means includes at least a mechanical actuator.

15. A vibrator according to claim 12, wherein the control means comprises a switch.

16. A vibrator according to claim 15, wherein the switch comprises a spring.

17. A vibrator according to claim 1, further including a gripping body.

18. A vibrator according to claim 1, wherein the contact member is made of plastic.

19. A vibrator according to claim 1, wherein the reinforcement is made of metal.

20. A vibrator according to claim 1, wherein the contact member has a trilobal general shape.

21. A massaging vibrator according to claim 1, wherein the contact member and reinforcement are deform able to form an impression corresponding the morphology of a portion of the user in the deformed position, and wherein the reinforcement maintains the contact member in the deformed position in the absence of an external stress.

22. A massaging vibrator according to claim 21, wherein the reinforcement and contact member are deformable so as to form an impression corresponding to the morphology of at least a portion of a user's face in the deformed position.

23. A massaging method using a massaging vibrator comprising:
providing a massaging vibrator including a massage assembly which includes a contact member, which is at least partly elastically deformable and which can be applied directly or indirectly to the skin of a user, wherein the contact member includes a deformed position when a stress is applied by the user, and wherein the massage assembly further includes a reinforcement for the contact member which is at least partly embedded inside the contact member, and further wherein said reinforcement is deformable jointly with the contact member and maintains said contact member in the deformed position when the user ceases to apply the stress, and wherein the massaging vibrator further includes at least one vibration generator directly in contact with the reinforcement within the contact member; and
applying the massaging vibrator directly or indirectly to an area of the skin to be massaged, and actuating the vibration generator of the massaging vibrator.

24. A method according to claim 23, further including deforming the contact member of the massaging vibrator before or after the vibration generator has been actuated.

25. A massaging vibrator comprising:
a massage assembly which includes a contact member, which is at least partly elastically deform able and which can be applied directly or indirectly to the skin of a user, wherein the contact member includes a deformed position when a stress is applied by the user;
wherein the massage assembly further includes a reinforcement for the contact member which is at least partly embedded inside the contact member, wherein said reinforcement is deformable jointly with the contact member and maintains said contact member in the deformed position when the user ceases to apply the stress; and
wherein the massaging vibrator further includes at least one vibration generator providing vibrations to the reinforcement and the contact member.

26. A massaging vibrator according to claim 25, wherein the contact member and reinforcement are deformable to form an impression corresponding the morphology of a portion of the user in the deformed position, and wherein the reinforcement maintains the contact member in the deformed position in the absence of an external stress.

27. A massaging vibrator according to claim 26, wherein the reinforcement and contact member are deformable so as to form an impression corresponding to the morphology of at least a portion of a user's face in the deformed position.
